(19) United States
(12) Patent Application Publication
(10) Pub. No.: US 2024/0163200 A1
(43) Pub. Date: May 16, 2024

(54) BGP for BIER-TE Path

(71) Applicant: Huawei Technologies Co., Ltd., Shenzhen (CN)

(72) Inventor: Huaimo Chen, Bolton, MA (US)

(21) Appl. No.: 18/391,217

(22) Filed: Dec. 20, 2023

Related U.S. Application Data
(63) Continuation of application No. PCT/US2022/034351, filed on Jun. 21, 2022.
(60) Provisional application No. 63/212,884, filed on Jun. 21, 2021.

(51) Int. Cl. H04L 45/036; H04L 45/02; H04L 45/741

(52) U.S. Cl. CPC H04L 45/036; H04L 45/04; H04L 45/741

(57) ABSTRACT

A method implemented by a controller configured to implement a border gateway protocol (BGP) and control a Bit Index Explicit Replication Traffic/Tree Engineering (BIER-TE) domain. The method includes generating an update message comprising a BIER-TE path subsequent address family indicator (SAFI), a network layer reachability information (NLRI) including a distinguisher, and an attribute including a type length value (TLV) having a tunnel type and a path bit positions sub-TLV. The method further includes distributing the update message to a bit forwarding router (BFR) in the BIER-TE domain.

### CROSS-REFERENCE TO RELATED APPLICATIONS

This patent application is a continuation of International Application No. PCT/US2022/034351 filed on Jun. 21, 2022, which claims the benefit of U.S. Provisional Patent Application No. 63/212,884 filed Jun. 21, 2021 by Futurewei Technologies, Inc., and titled “PCE for BIER-TE Path,” each of which is hereby incorporated by reference.

### TECHNICAL FIELD

The present disclosure is generally related to the field of network communication and, in particular, to a border gateway protocol (BGP) for Bit Index Explicit Replication-Traffic/Tree Engineering (BIER-TE).

### BACKGROUND

BIER mechanisms provide optimized forwarding of multicast data packets through a BIER domain. BIER domains may not require the use of a protocol for explicitly building multicast distribution trees. Further, BIER domains may not require intermediate nodes to maintain any per-flow state. BIER is described in further detail in Internet Engineering Task Force (IETF) document Request for Comments (RFC) 8279 entitled “Multicast Using Bit Index Explicit Replication (BIER)” by I J. Wijnands, et al., published November 2017.

Traffic Engineering (TE) is the process of steering traffic across a telecommunications network to facilitate efficient use of available bandwidth between a pair of routers. Bit Index Explicit Replication (BIER) Traffic/Tree Engineering (BIER-TE) is described in IETF document “Tree Engineering for Bit Index Explicit Replication (BIER-TE)” by T. Eckert, et al., published Jul. 9, 2021.

### SUMMARY

The disclosed aspects/embodiments provide techniques that allow a controller utilizing BGP to create and distribute a Bit Index Explicit Replication Traffic/Tree Engineering (BIER-TE) path for a BIER-TE domain. In order to facilitate the techniques, the present disclosure provides extensions to BGP, which are carried in update messages. The extensions are implemented using type length value (TLV) structures and sub-TLV structures. Using the extensions, packet routing within the BIER-TE domain is improved relative to existing techniques.

A first aspect relates to a method implemented by a controller configured to implement a border gateway protocol (BGP) and control a Bit Index Explicit Replication Traffic/Tree Engineering (BIER-TE) domain, comprising: generating an update message comprising a BIER-TE path subsequent address family indicator (SAFI), a network layer reachability information (NLRI) including a distinguisher field, and an attribute including a type length value (TLV) having a tunnel type and a path bit positions sub-TLV; and distributing the update message to a bit forwarding router (BFR) in the BIER-TE domain.

Optionally, in any of the preceding aspects, another implementation of the aspect provides that the distinguisher field comprises a value that uniquely identifies content associated with the NLRI or of a BIER-TE path.

Optionally, in any of the preceding aspects, another implementation of the aspect provides that the NLRI includes a tunnel identifier field comprising a sub-domain identifier (ID), a bit forwarding router identifier (BFR-id) field, and a tunnel ID, wherein the sub-domain identifier identifies a sub-domain through which a BIER-TE tunnel crosses, the BFR-id field identifies a bit forwarding ingress router (BFIR) of the BIER-TE tunnel, and the tunnel ID uniquely identifies the BIER-TE tunnel within the BFIR and the sub-domain.

Optionally, in any of the preceding aspects, another implementation of the aspect provides that the tunnel identifier field comprises a BFR prefix of a bit forwarding ingress router (BFIR) of a BIER-TE tunnel.

Optionally, in any of the preceding aspects, another implementation of the aspect provides that the attribute comprises a tunnel encapsulation attribute (TEA).

Optionally, in any of the preceding aspects, another implementation of the aspect provides that the attribute comprises a P-Multicast Service Interface (PSMI) tunnel attribute (PTA).

Optionally, in any of the preceding aspects, another implementation of the aspect provides that the path bit positions sub-TLV includes a bit index forwarding table identifier (BIFT-id) field, a set identifier (SI) field, and a bitstring field.

Optionally, in any of the preceding aspects, another implementation of the aspect provides that the update message is distributed to a BGP peer running on a bit forwarding ingress router (BFIR) of the BIER-TE domain.

Optionally, in any of the preceding aspects, another implementation of the aspect provides that the TLV further comprises a path name sub-TLV that encodes a name of a BIER-TE path.

Optionally, in any of the preceding aspects, another implementation of the aspect provides that the TLV further comprises a traffic description sub-TLV that encodes multicast traffic transported by a BIER-TE path.

Optionally, in any of the preceding aspects, another implementation of the aspect provides that the TLV further comprises a service sub-TLV that contains a service identifier (ID) or a label to be added into a packet to be carried by a BIER-TE path.

Optionally, in any of the preceding aspects, another implementation of the aspect provides that the TLV further comprises a path identifier sub-TLV that contains a sub-domain identifier (sub-domain-id) field, a bit forwarding ingress router identifier (BFIR-id) field, a tunnel identifier (ID), and a path number field.

Optionally, in any of the preceding aspects, another implementation of the aspect provides that the update message further comprises an address family indicator (AFI) that identifies Internet Protocol version four (IPv4) or Internet Protocol version six (IPv6).

A second aspect relates to a controller configured to implement a border gateway protocol (BGP) and control a Bit Index Explicit Replication Traffic/Tree Engineering (BIER-TE) domain, comprising: a memory storing instructions; and a processor coupled to the memory, the processor configured to execute the instructions to cause the controller to: generate an update message comprising a BIER-TE path subsequent address family indicator (SAFI), a network layer reachability information (NLRI) including a distinguisher field and an attribute including a type length value (TLV) having a tunnel type and a path bit positions sub-TLV; and distribute the update message to a bit forwarding router (BFR) in the BIER-TE domain.

Optionally, in any of the preceding aspects, another implementation of the aspect provides that the distinguisher field comprises a value that uniquely identifies content associated with the NLRI or of a BIER-TE path.

Optionally, in any of the preceding aspects, another implementation of the aspect provides that the NLRI includes a tunnel identifier field comprising a sub-domain identifier (ID), a bit forwarding router identifier (BFR-id), and a tunnel ID, wherein the sub-domain identifier identifies a sub-domain through which a BIER-TE tunnel crosses, the BFR-id identifies a bit forwarding ingress router (BFIR) of the BIER-TE tunnel, and the tunnel ID uniquely identifies the BIER-TE tunnel within the BFIR and the sub-domain.

Optionally, in any of the preceding aspects, another implementation of the aspect provides that the tunnel identifier field comprises a BFR prefix of a bit forwarding ingress router (BFIR) of a BIER-TE tunnel.

Optionally, in any of the preceding aspects, another implementation of the aspect provides that the attribute comprises a tunnel encapsulation attribute (TEA).

Optionally, in any of the preceding aspects, another implementation of the aspect provides that the attribute comprises a P-Multicast Service Interface (PSMI) tunnel attribute (PTA).

Optionally, in any of the preceding aspects, another implementation of the aspect provides that the path bit positions sub-TLV includes a bit index forwarding table identifier (BIFT-id) field, a set identifier (SI) field, and a bitstring field.

Optionally, in any of the preceding aspects, another implementation of the aspect provides that the update message is distributed to a BGP peer running on a bit forwarding ingress router (BFIR) of the BIER-TE domain.

Optionally, in any of the preceding aspects, another implementation of the aspect provides that the TLV further comprises a path name sub-TLV that encodes a name of a BIER-TE path.

Optionally, in any of the preceding aspects, another implementation of the aspect provides that the TLV further comprises a traffic description sub-TLV that encodes multicast traffic transported by a BIER-TE path.

Optionally, in any of the preceding aspects, another implementation of the aspect provides that the TLV further comprises a service sub-TLV that contains a service identifier (ID) or a label to be added into a packet to be carried by a BIER-TE path.

Optionally, in any of the preceding aspects, another implementation of the aspect provides that the TLV further comprises a path identifier sub-TLV that contains a sub-domain identifier (sub-domain-id) field, a bit forwarding ingress router identifier (BFIR-id) field, a tunnel identifier (ID), and a path number field.

Optionally, in any of the preceding aspects, another implementation of the aspect provides that the update message further comprises an address family indicator (AFI) that identifies Internet Protocol version four (IPv4) or Internet Protocol version six (IPv6).

A third aspect relates to a non-transitory computer readable medium comprising a computer program product for use by a controller, the computer program product comprising computer executable instructions stored on the non-transitory computer readable medium that, when executed by one or more processors, cause the controller to execute any of the disclosed embodiments.

A fourth aspect relates to a controller configured to implement a border gateway protocol (BGP) and control a Bit Index Explicit Replication Traffic/Tree Engineering (BIER-TE) domain, comprising: means for generating an update message comprising a BIER-TE path subsequent address family indicator (SAFI), a network layer reachability information (NLRI) including a distinguisher and an attribute including a type length value (TLV) having a tunnel type and a path bit positions sub-TLV; and means for distributing the update message to a bit forwarding router (BFR) in the BIER-TE domain.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a BIER-TE topology including a BIER-TE domain.

FIG. 2 is a schematic diagram of a BIER-TE bit index forwarding table (BIFT) of a network node in the BIER-TE domain.

FIG. 3 is a schematic diagram of a Network Layer Reachability Information (NLRI) according to an embodiment of the disclosure.

FIG. 4 is a schematic diagram of a Tunnel Encapsulation Attribute (TEA) according to an embodiment of the disclosure.

FIG. 5 is a schematic diagram of a P-Multicast Service Interface (PSMI) tunnel attribute (PTA) according to an embodiment of the disclosure.

FIG. 6 is a schematic diagram of a Path BitPositions Sub-Type Length Value (sub-TLV) according to an embodiment of the disclosure.

FIG. 7 is a schematic diagram of a Path Name Sub-TLV according to an embodiment of the disclosure.

FIG. 8 is a schematic diagram of a Service Label Sub-TLV according to an embodiment of the disclosure.

FIG. 9 is a schematic diagram of a 32 Bits Service Identifier (ID) Sub-TLV according to an embodiment of the disclosure.

FIG. 10 is a schematic diagram of a 128 Bits Service Identifier (ID) Sub-TLV (ERO) according to an embodiment of the disclosure.

FIG. 11 is a schematic diagram of a Multicast Traffic for Internet Protocol version 4 (IPv4) Sub-TLV according to an embodiment of the disclosure.

FIG. 12 is a schematic diagram of a Multicast Traffic for Internet Protocol version 6 (IPv6) Sub-TLV according to an embodiment of the disclosure.

FIG. 13 is a schematic diagram of Path Identifier Sub-TLV according to an embodiment of the disclosure.

FIG. 14 is a method implemented by controller configured to implement a border gateway protocol (BGP) and control a BIER-TE domain according to an embodiment of the disclosure.

FIG. 15 is a schematic diagram of a network apparatus according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Existing techniques provide a controller (e.g., a path computation element (PCE), etc.) with border gateway protocol (BGP) extensions for BIER, but not for BIER-TE. This causes inefficiency and leads to difficulties in computing and setting up paths (e.g., point to multipoint (P2MP) paths) through the BIER-TE domain.

Disclosed herein are techniques that allow a controller utilizing BGP to create and distribute a Bit Index Explicit Replication Traffic/Tree Engineering (BIER-TE) path for a BIER-TE domain. In order to facilitate the techniques, the present disclosure provides extensions to BGP, which are carried in update messages. The extensions are implemented using type length value (TLV) structures and sub-TLV structures. Using the extensions, packet routing within the BIER-TE domain is improved relative to existing techniques.

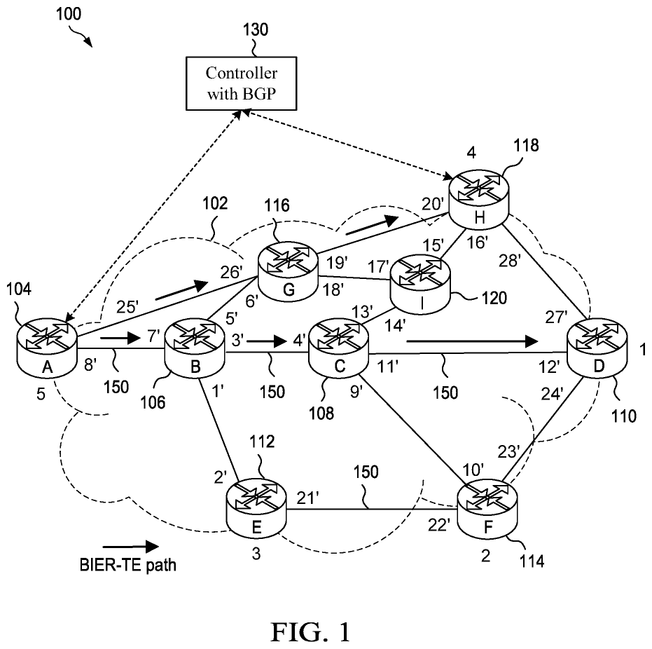

FIG. 1 is a schematic diagram of a BIER-TE topology 100 including a BIER-TE domain 102. The BIER-TE domain 102 may be part of a larger BIER-TE domain (not shown). As such, the BIER-TE domain 102 may be referred to herein as a BIER-TE sub-domain. The BIER-TE domain 102 comprises a plurality of network nodes 104, 106, 108, 110, 112, 114, 116, 118, and 120. While nine network nodes 104-120 are shown in the BIER-TE domain 102, more or fewer nodes may be included in practical applications.

Each of the network nodes 104-120 is a bit forwarding router (BFR). Some of the network nodes, namely the network nodes 104, 110, 112, 114 and 118, are disposed at an edge of the BIER-TE domain 102. The network nodes 104, 110, 112, 114 and 118 receiving multicast packets from outside the BIER-TE domain 102 may be referred to as a bit forwarding ingress router (BFIR) or ingress BFR. The network nodes 104, 110, 112, 114 and 118 transmitting multicast packets out of the BIER-TE domain 102 may be referred to as a bit forwarding egress router (BFER) or egress BFR. Depending on the direction of multicast packet traffic, each of the network nodes 104, 110, 112, 114 and 118 may function as a BFIR or a BFER.

As shown in FIG. 1, the bit position (BP) for forward connected (fw-con) adjacency between the various network nodes 104-120 is identified. In the illustrated example, the BP for a fw-con adjacency is represented as i′, where i is an integer corresponding to one of the forward connected adjacencies between the network nodes 104-120 in the BIER-TE domain 102. In the illustrated embodiment of FIG. 1, there are twenty-eight total BPs for twenty-eight fw-con adjacencies. However, there may be more or fewer BPs for fw-con adjacencies in other BIER-TE domains in practical applications.

As an example of how the BPs for fw-con adjacencies operate with regard to FIG. 1, 7′ is the BP for the fw-con adjacency from node 104 to node 106, and 8′ is the BP for the fw-con adjacency from node 106 to node 104. 7′ is configured on the link from node 104 to node 106 and advertised to all the network nodes in the network. 8′ is configured on the link from node 106 to node 104 and advertised to all the network nodes in the network. As another example, 4′ is the BP for the fw-con adjacency from node 106 to node 108, and 3′ is the BP for the fw-con adjacency from node 108 to node 106. 4′ is configured on the link from node 106 to node 108 and advertised to all the network nodes in the network. 3′ is configured on the link from node 108 to node 106 and advertised to all the network nodes in the network. As another example, 2′ is the BP for the fw-con adjacency from node 106 to node 112, and 1′ is the BP for the fw-con adjacency from node 112 to node 106. 2′ is configured on the link from node 106 to node 112 and advertised to all the network nodes in the network. 1′ is configured on the link from node 112 to node 106 and advertised to all the network nodes in the network. The other BPs for fw-con adjacencies may be determined in a similar fashion as represented by the various values for i′ on FIG. 1. For ease of discussion, each BP for fw-con adjacency may be simply referred to herein as the BP or the adjacency.

Each of the network nodes 104-120 may be referred to herein as a destination network node or a BFER. The network nodes 104-120 may each be assigned a BP, a set index or set identifier (SI), and a bitstring (a.k.a., BitString, Bit String, or bit string). The BP of a BFER is called a local decapsulation (decap) adjacency or local decap BP. In the illustrated example, the BP of a BEER is represented as j, where j is an integer corresponding to one of the local decap adjacencies in the BIER-TE domain 102. In the illustrated embodiment of FIG. 1, there are five local decap adjacencies for five BFERs 104, 110, 112, 114, and 118. As an example, the BPs of BFERs 104, 110, 112, 114, and 118 may be 5, 1, 3, 2, and 4, respectively. For simplicity, these BPs for local decap adjacencies are represented by (SI:BitString), where SI=0 and BitString is a string of 8 bits. BPs 1, 2, 3, 4, and 5 are collectively represented by 1 (0:00000001), 2 (0:00000010), 3 (0:00000100), 4 (0:00001000), and 5 (0:00010000), respectively. The BP of a BFER is advertised by the BFER to all the nodes in the network.

In an embodiment, the BPs for fw-con adjacencies are represented by (SI:BitString), where SI>=6 and BitString is a string of 8 bits. For example, the BP of 3′ has a SI of 6, and has a bitstring of 00000100 (collectively represented by 3′ (6:00000100). Assuming the SI of 6 corresponds to the first set of eight BPs for fw-con adjacencies, the BP of 3′ corresponds to the third bit in the bitstring from the right set to one. That is, when the SI is 6, the BP of 1′ corresponds to the first bit set to one, the BP of 2′ corresponds to the second bit set to one, the BP of 3′ corresponds to the third bit set to one, the BP of 4′ corresponds to the fourth bit set to one, and the BP of 5′ corresponds to the fifth bit set to one, and so on.

Assuming the SI of 7 corresponds to the second set of eight BPs for fw-con adjacencies immediately following the first set of eight BPs for fw-con adjacencies, the BPs of 9′ and 10′ are collectively represented by 9′ (7:00000001) and 10′ (7:00000010), respectively. That is, when the SI is 7, the BP of 9′ corresponds to the first bit set to one, and the BP of 10′ corresponds to the second bit set to one, and so on. In this way, the BP is represented by a number that indicates which bit is set in the BitString.

Each of the network nodes 104-120 has one or more neighbor nodes. As used herein, a neighbor node refers to a network node that is only one hop away from the network node. For example, network node 106 has four neighbor nodes in FIG. 1, namely network node 104, network node 108, network node 112, and network node 116. Indeed, each of network node 104, network node 108, network node 112, and network node 116 is only one hop away from network node 106.

The network nodes 104-120 in FIG. 1 are coupled to, and communicate with each other, via links 150. The links 150 may be wired, wireless, or some combination thereof. In an embodiment, each of the links 150 may have a cost. The cost of each of the links 150 may be the same or different, depending on the BIER-TE topology 100 and the conditions therein.

The BIER domain 102 is controlled by a network controller 130 (or simply, a controller) capable of implementing BGP. BGP is a standardized exterior gateway protocol designed to exchange routing and reachability information among autonomous systems (AS) on the Internet. BGP is classified as a path-vector routing protocol, and BGP makes routing decisions based on paths, network policies, or rule-sets configured by a network administrator.

In an embodiment, one or more of the network nodes 104-120 may request that the network controller 130 calculate the BIER-TE path through the BIER-TE domain 102. Once calculated, the BIER-TE path may be distributed by the network controller 130 in different ways.

For example, when the network controller 130 is directly connected to the ingress network node 104 of the BIER-TE path, the network controller 130 transmits an update message (a.k.a., a BGP update message) to the ingress network node 104 as well as one or more of the other network nodes 106-120. The update message includes a route target (RT) and a “no advertise” instruction. When the RT does not match the ID of the network node that received the update message, the network node is not the ingress network node of the BIER-TE path. Due to the “no advertise” instruction, the network nodes do not distribute the update message to their neighbor network nodes. When the RT does match the ID of the network node that received the update message, the network node is the ingress network node of the BIER-TE path (e.g., network node 104). As such, the ingress network node installs a forwarding entry for the BIER-TE path in a forwarding table stored on the ingress network node.

As another example, when the network controller 130 is not directly connected to the ingress network node 104 of the BIER-TE path, the network controller 130 transmits an update message to one or more of the other network nodes 106-120. The update message includes the RT and an “advertise” instruction. When the RT does not match the ID of the network node that received the update message, a network node advertises the update message to its neighbor network nodes according to the BGP propagation rules. Eventually, the ingress network node of the BIER-TE path, which has an ID that matches the RT, receives the update message from another network node. As such, the ingress network node installs a forwarding entry for the BIER-TE path in forwarding table stored on the ingress network node.

Additional details regarding the update message may be found in Internet Engineering Task Force (IETF) Request for Comments (RFC) 4271 entitled “A Border Gateway Protocol 4 (BGP-4)” by Y. Rekhter, et al., published January 2006.

Using the BIER-TE topology 100 of FIG. 1, an example of how the BIER-TE path calculated by the network controller 130 is utilized in the BIER-TE domain 102. To begin, assume the network controller 130 calculated a BIER-TE path from network node A to network nodes H and D, which is represented by the following BPs: {26′, 20′, 4, 7′, 4′, 12′, 1}. After the BIER-TE path has been calculated, the network controller 130 distributes that BIER-TE path to the ingress network node 104 for the BIER-TE path using an update message.

When the ingress network node 104 receives a packet (e.g., a multicast packet) from outside the BIER-TE domain 102, the ingress network node 104 encapsulates the packet with the BPs for the BIER-TE path. The encapsulated packet has the form {26′, 20′, 4, 7′, 4′, 12′, 1}[packet].

The ingress network node 104 removes bit position 26′ and 7′ from the BIER-TE path and forwards the encapsulated packet to the network node 116, which corresponds to bit position 26′. When received by the network node 116, the encapsulated packet has the form {20′, 4, 4′, 12′, 1}[packet]. The network node 116 removes bit position 20′ from the BIER-TE path and forwards the encapsulated packet to the network node 118, which corresponds to bit position 20′. When received by the network node 118, the encapsulated packet has the form {4, 4′, 12′, 1}[packet]. The network node 118, which has local decap bit position 4, decapsulates the encapsulated packet and transmits the packet to a multicast overlay outside the BIER-TE domain 102.

In addition to the above, the ingress network node 104 removes bit position 7′ and 26′ from the BIER-TE path and forwards the encapsulated packet to the network node 106, which corresponds to bit position 7′. When received by the network node 106, the encapsulated packet has the form {20′, 4, 4′, 12′, 1}[packet]. The network node 106 removes bit position 4′ from the BIER-TE path and forwards the encapsulated packet to the network node 108, which corresponds to bit position 4′. When received by the network node 108, the encapsulated packet has the form {20′, 4, 12′, 1}[packet]. The network node 108 removes bit position 12′ from the BIER-TE path and forwards the encapsulated packet to the network node 110, which corresponds to bit position 12′. When received by the network node 110, the encapsulated packet has the form {20′, 4, 1}[packet]. The network node 110, which has local decap bit position 1, decapsulates the encapsulated packet and transmits the packet to a multicast overlay outside the BIER-TE domain 102.

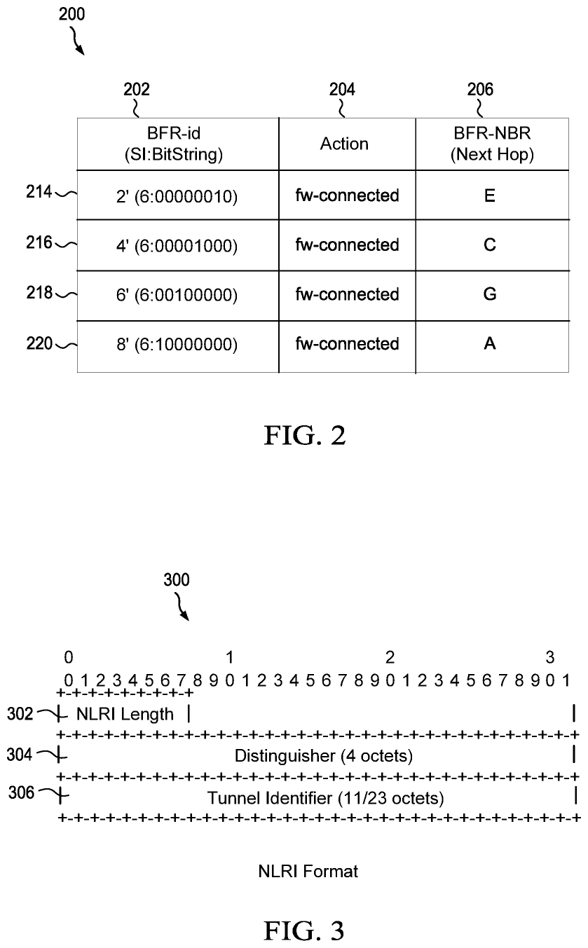

In order to route the packet as described in the examples above, each of the network nodes 104-120 in the BIER-TE topology 100 in FIG. 1 generates a BIER-TE bit index forwarding table (BIFT). FIG. 2 is a schematic diagram of a BIER-TE BIFT 200 built on the network node 106 in FIG. 1. As shown, the BIER-TE BIFT 200 includes three columns of information. The first column 202 includes the BP, SI, and BitString (a.k.a., bitstring) of each adjacency directly coupled to the network node 106 in the BIER-TE topology 100. The adjacency in column 202 may be a local decapsulation (local-decap) adjacency of a destination network node (e.g., destination network node 104) or a forward connected adjacency to a neighbor network node (e.g., network node 108) from network node 106. A second column 204 indicates the action to be taken by the network node 104, which in the illustrated example is either a forward connected adjacency or a local decapsulation (local-decap). At a local decapsulation, an egress network node decapsulates the received packet and forwards the payload to the multicast overlay (which forwards the payload to a customer receiver outside the BIER-TE domain). A third column 206 identifies the neighbor node (BFR-NBR) of the network node 106 used to reach the adjacent network node identified by the adjacency in the first column 202, which is why the neighbor node in the third column 206 may also be referred to as the next hop of the network node 106.

When the network node 104 receives a packet with a point-to-multipoint (P2MP) path (e.g., a BIER-TE path) including 2′, the network node 106 utilizes the first row 214 of the BIER-TE BIFT 200 to forward the packet. That is, the network node 106 sends the packet to the network node 112 (i.e., network node E) identified in the third column 206 based on the forward connected adjacency action in the second column 204. When the network node 106 receives a packet with a P2MP path including 4′, the network node 106 utilizes the second row 216 of the BIER-TE BIFT 200 to forward the packet. That is, the network node 106 sends the packet to the network node 108 (i.e., network node C) identified in the third column 206 based on the forward connected adjacency action in the second column 204.

In order to communicate information regarding the BIER-TE path using the update message as noted above, extensions to BGP are provided. For example, a new subsequent address family indicator (SAFI) is defined. In an embodiment, the new SAFI is a number that indicates or signifies that BIER-TE is being used. The new SAFI is carried by the update message.

The update message transmitted by the network controller 130 to one or more of the network nodes 104-120 also carries a new Network Layer Reachability Information (NLRI). FIG. 3 is a schematic diagram of a NLRI 300 according to an embodiment of the disclosure. As shown in FIG. 3, the NLRI 300 includes an NLRI length field 302, a distinguisher field 304, and a tunnel identifier field 306. The NLRI length field 302 includes a value that represents a length of the NLRI. When the value of the NLRI length field 302 is anything other than 15 or 27, the NLRI 300 is corrupted and the update message carrying the NLRI 300 is ignored. In an embodiment, the NLRI length field 302 is 1 octet.

The distinguisher field 302 comprises a value that uniquely identifies BIER-TE content associated with the NLRI 300 or of a BIER-TE path. In an embodiment, the distinguisher field 304 is 4 octets.

The tunnel identifier field 306 comprises a sub-domain identifier (sub-domain-id), a bit forwarding router identifier (BFR-id), and a tunnel ID. The sub-domain identifier identifies a sub-domain through which a BIER-TE tunnel crosses. In an embodiment, the sub-domain identifier comprises 1 octet. The BFR-id identifies a BFIR of the BIER-TE tunnel. In an embodiment, the BFR-id comprises 2 octets. The tunnel ID uniquely identifies the BIER-TE tunnel within the BFIR and the sub-domain (e.g., BIER-TE sub-domain 102). In an embodiment, the tunnel ID comprises 4 octets. In an embodiment, the tunnel identifier field 306 also comprises a BFR-prefix of a BFIR of a BIER-TE tunnel. In an embodiment, the BFR-prefix comprises 4 octets for Internet Protocol version 4 (IPv4) and 16 octets for Internet Protocol version 6 (IPv6).

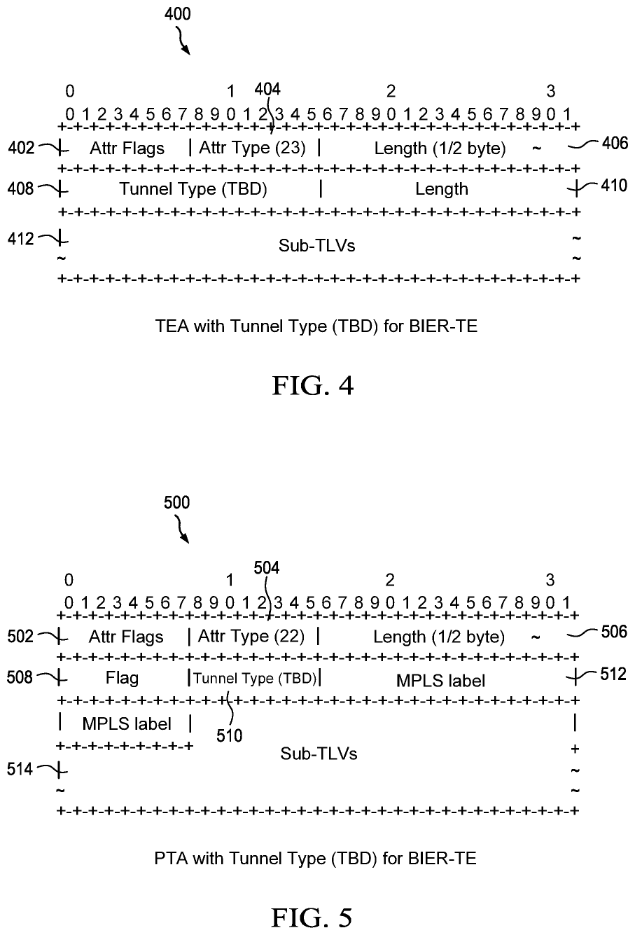

The update message transmitted by the network controller 130 to one or more of the network nodes 104-120 also carries an attribute. The NLRI 300 is associated with the attribute. In an embodiment, the attribute is a Tunnel Encapsulation Attribute (TEA) 400 as shown in FIG. 4. The TEA 400 includes an attribute flags field 402, an attribute type field 404, a length field 406, a tunnel type field 408, a length field 410, and a sub-TLVs field 412. The attribute flags field 402 includes a value comprising bit 0, 1, 2, and 3; wherein bit 0 is set to indicate whether the attribute is optional (if set to 1) or well-known (if set to 0), bit 1 is set to indicate whether an optional attribute is transitive (if set to 1) or non-transitive (if set to 0), bit 2 is set to indicate whether the information contained in the optional transitive attribute is partial (if set to 1) or complete (if set to 0), and bit 3 is set to indicate whether the attribute length is one octet (if set to 0) or two octets (if set to 1). The attribute type field 404 includes a value (e.g., 23) that indicates a type of tunnel encapsulation attribute. The length field 406 includes a value that indicates a length of the TEA 400.

The tunnel type field 408 includes a value that identifies a BIER-TE tunnel. The length field 410 includes a value that identifies a length of the sub-TLVs in the sub-TLVs field 412. The sub-TLVs field 412 may include one or more sub-TLVs. The tunnel type field 408, the length field 410, and the sub-TLVs field 412 may be collectively referred to as a tunnel encapsulation TLV for BIER-TE (or simply a TLV).

In an embodiment, the attribute in the update message is a P-Multicast Service Interface (PSMI) tunnel attribute (PTA) 500 as shown in FIG. 5. The PTA 500 includes an attribute flags field 502, an attribute type field 504, a length field 506, a flag field 508, a tunnel type field 510, a Multi-Protocol Label Switching (MPLS) label field 512, and a sub-TLVs field 514. The attribute flags field 502 includes a value that is the same as or similar to the value in the attribute flags field 402. The attribute type field 504 includes a value (e.g., 22) that indicates a type of PMSI tunnel attribute. The length field 506 includes a value that indicates a length of the PTA 500.

The flag field 508 includes a value that indicates whether leaf information is required. The tunnel type field 510 includes a value that identifies a BIER-TE tunnel. The MPLS label field 512 includes a value that identifies an MPLS label. The sub-TLVs field 514 may include one or more sub-TLVs. The flag field 508, the tunnel type field 510, the MPLS label field 512, and the sub-TLVs field 514 may be collectively referred to as a tunnel encapsulation TLV for BIER-TE (or simply a TLV).

In an embodiment, the sub-TLVs field 412 and the sub-TLVs field 514 include one or more of a path BitPositions sub-TLV (a.k.a., path sub-TLV), a path name sub-TLV, a service sub-TLV, a traffic description sub-TLV, and a path identifier sub-TLV. Each of these structures are described in further detail below.

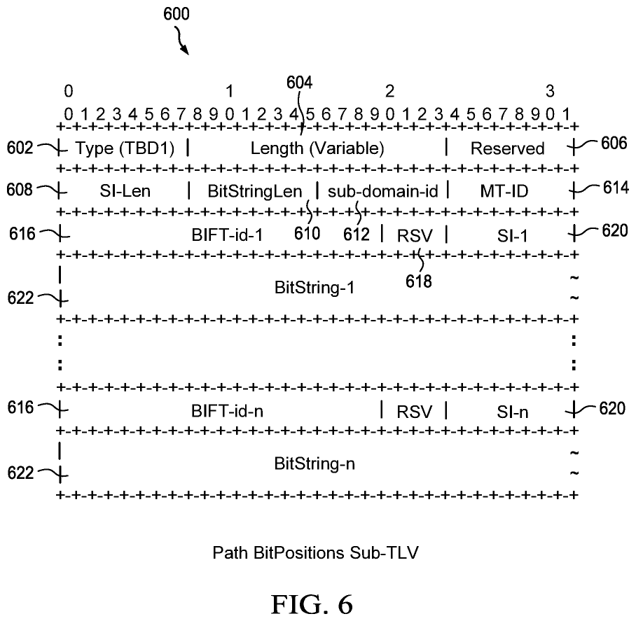

FIG. 6 is a schematic diagram of a path BitPositions sub-TLV 600. In an embodiment, the path BitPositions sub-TLV 600 includes a type field 602, a length field 604, a reserved field 606, a set identifier (SI) length field 608, a bitstring length field 610, a sub-domain ID field 612, a multi-topology (MT)-ID field 614, a bit index forwarding table identifier (BIFT-id) field 616, a reserved field 618, a set identifier (SI) field 620, and a bitstring field 622.

The type field 602 includes a value that identifies the type of sub-TLV (e.g., a path BitPositions sub-TLV 600). The length field 604 includes a value that identifies a length of the sub-TLV. The reserved field 606 is set to 0 and ignored by the receiver. The SI length field 608 includes a value that indicates a length of the SI field 620 in bits.

In an embodiment, the bitstring length field 610 includes a value that indicates a length of the bitstring field 622 according to IETF document RFC 8296 entitled “Encapsulation for Bit Index Explicit Replication (BIER) in MPLS and Non-MPLS Networks” by I J. Wijnands, et al., published January 2018. As an example, when k is the length of the BitString, the value BitStringLen is log 2(k)−5. As such, BitStringLen=1 indicates k=64, and BitStringLen=7 indicates k=4096.

The sub-domain ID field 612 includes a unique value that identifies the sub-domain within the BIER domain. The MT-ID field 614 includes a value that identifies the topology (e.g., BGP, BIER-TE, etc.) associated with the BIER sub-domain. The BIFT-id field 616 includes a value that identifies a BIFT (e.g., the BIER-TE BIFT 200 of FIG. 2). The reserved field 618 is set to 0 and ignored by the receiver.

The SI field 620 includes a value that identifies the set (e.g., 6 from the BIER-TE BIFT 200 of FIG. 2). The bitstring field 622 includes the bitstring (e.g., 00001010) corresponding to the BPs in the BIFT-id field 616. As such, each SI-i and BitString-i (i=1, 2, . . . , n) pair represents and encodes a set of bit positions on the BIER-TE path. All of the SI and BitString pairs in the path BitPositions sub-TLV 600 represent and encode the BIER-TE path. That is, the SI and BitString pairs represent and encode all of the bit positions of the BIER-TE path.

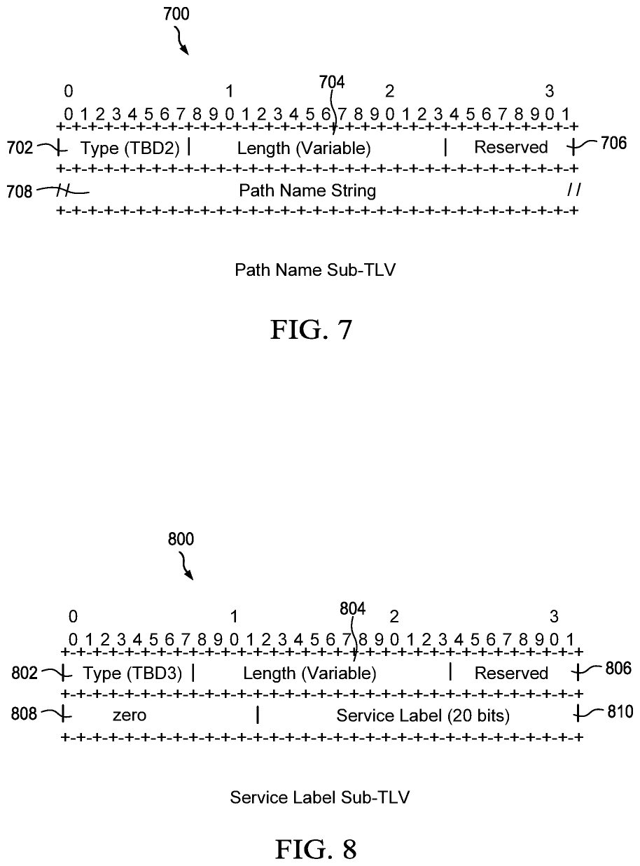

FIG. 7 is a schematic diagram of a path name sub-TLV 700 that contains the name of a BIER-TE path. The path name sub-TLV 700 comprises a type field 702, a length field 704, a reserved field 706, and a path name string field 708. The type field 702 includes a value that indicates that the sub-TLV is a path name sub-TLV 700. The length field 704 includes a value that indicates a length of the sub-TLV. The reserved field 706 is set to 0 and ignored by the receiver. The path name string field 708 represents and encodes the name of the BIER-TE path in a string of characters.

FIG. 8 is a schematic diagram of a service sub-TLV 800 that contains a service ID or label to be added into a packet to be carried by a BIER-TE path. The service sub-TLV 800 comprises a type field 802, a length field 804, a reserved field 806, a zero field 808, and a service label field 810. The type field 802 includes a value that indicates the sub-TLV is a service sub-TLV 800. The length field 804 includes a value that indicates a length of the sub-TLV. The reserved field 806 is set to 0 and ignored by the receiver. The zero field 808 includes a value of zeros. The service label field 810 includes a least significant 20 bits, which represents a label of 20 bits.

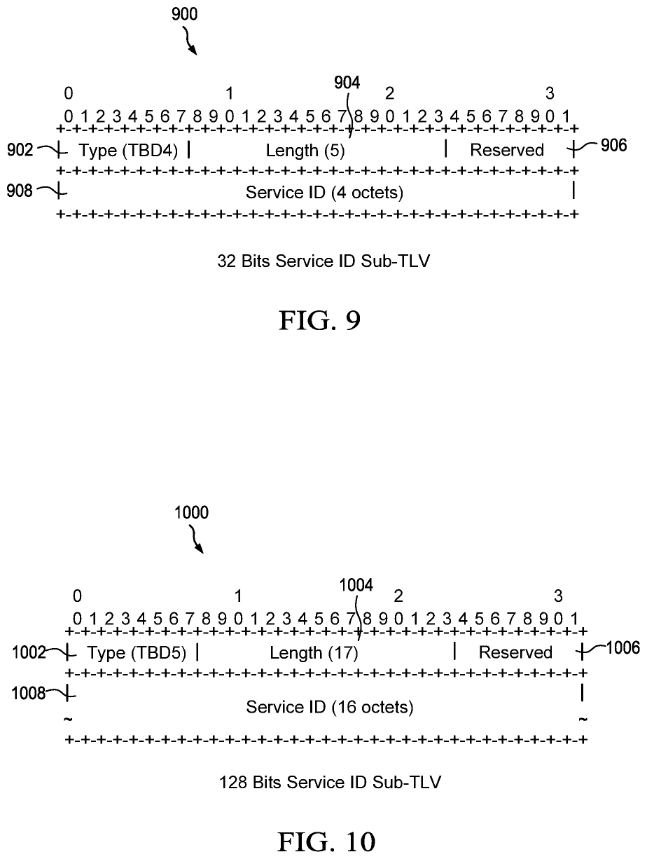

FIG. 9 is a schematic diagram of a service sub-TLV 900 that contains a service ID to be added into a packet to be carried by a BIER-TE path. The service sub-TLV 900 comprises a type field 902, a length field 904, a reserved field 906, and a service ID field 908. The type field 902 includes a value that indicates the sub-TLV is a service sub-TLV 900. The length field 904 includes a value that indicates a length of the sub-TLV. The reserved field 906 is set to 0 and ignored by the receiver. The service ID field 908 includes a value that represents a 32 bit service ID.

FIG. 10 is a schematic diagram of a service sub-TLV 1000 that contains a service ID to be added into a packet to be carried by a BIER-TE path. The service sub-TLV 1000 comprises a type field 1002, a length field 1004, a reserved field 1006, and a service ID field 1008. The type field 1002 includes a value that indicates the sub-TLV is a service sub-TLV 1000. The length field 1004 includes a value that indicates a length of the sub-TLV. The reserved field 1006 is reserved for later use. The service ID field 1008 includes a value that represents a 128 bit service ID.

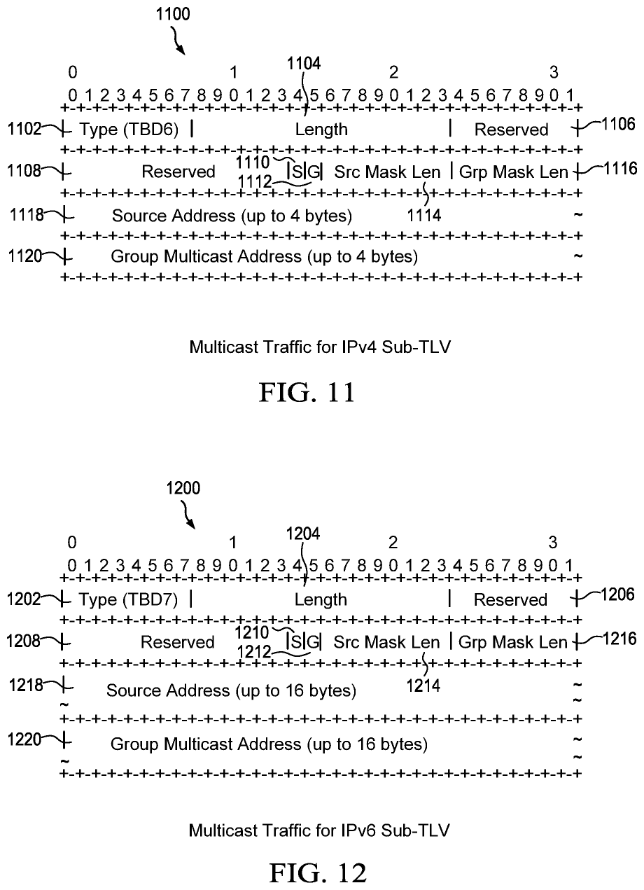

FIG. 11 is a schematic diagram of a traffic for IPv4 description sub-TLV 1100 that describes the traffic to be imported into a BIER-TE path. The traffic for IPv4 description sub-TLV 1100 comprises a type field 1102, a length field 1104, reserved fields 1106 and 1108, an S bit field 1110, a G bit field 1112, a source mask length field 1114, a group mask length field 1116, a source address field 1118, and a group multicast address field 1120.

The type field 1102 includes a value that indicates that the sub-TLV is a traffic for IPv4 description sub-TLV 1100. The length field 1104 includes a value that indicates a length of the sub-TLV. The reserved fields 1106 and 1108 (which may be one field) are set to zero and ignored by the receiver. The S-bit field 1110 and the G-bit field 1112 describe the multicast wildcarding in use. When the S bit is set (e.g., has a value of 1), then source wildcarding is in use and the values in the source mask length field 1114 and source address field 1118 are ignored. When the G bit is set (e.g., has a value of 1), then group wildcarding is in use and the values in the group mask length field 1116 and group multicast address field 1120 are ignored. The G bit is not set unless the S bit is also set. Therefore, the receiver responds with an error (Malformed Multicast Traffic) when a traffic description sub-TLV 1100 is received with S bit=0 and G bit=1.

The source mask length field 1114 includes a value that indicates a length of the source address field 1118. The group mask length field 1116 includes a value that indicates a length of the group multicast address field 1120. The source address field 1118 contains source prefixes for matching against packets and is up to 4 bytes in length. The group multicast address field 1120 contains group prefixes for matching against packets and is up to 4 bytes in length.

FIG. 12 is a schematic diagram of a traffic for IPv6 description sub-TLV 1200 that describes the traffic to be imported into a BIER-TE path. The traffic for IPv6 description sub-TLV 1200 comprises a type field 1202, a length field 1204, reserved fields 1206 and 1208, an S bit field 1210, a G bit field 1212, a source mask length field 1214, a group mask length field 1216, a source address field 1218, and a group multicast address field 1220.

The type field 1202 includes a value that indicates that the sub-TLV is a traffic for IPv6 description sub-TLV 1200. The length field 1204 includes a value that indicates a length of the sub-TLV. The reserved fields 1206 and 1208 (which may be one field) are set to zero and ignored by the receiver. The S bit field 1210 and the G bit field 1212 describe the multicast wildcarding in use. When the S bit is set (e.g., has a value of 1), then source wildcarding is in use and the values in the source mask length field 1214 and source address field 1218 are ignored. When the G bit is set (e.g., has a value of 1), then group wildcarding is in use and the values in the group mask length field 1216 and group multicast address field 1220 are ignored. The G bit is not set unless the S bit is also set. Therefore, the receiver responds with an error (Malformed Multicast Traffic) when a traffic description sub-TLV 1200 is received with S bit=0 and G bit=1.

The source mask length field 1214 includes a value that indicates a length of the source address field 1218. The group mask length field 1216 includes a value that indicates a length of the group multicast address field 1220. The source address field 1218 contains source prefixes for matching against packets and is up to 16 bytes in length. The group multicast address field 1220 contains group prefixes for matching against packets and is up to 16 bytes in length.

In an embodiment, and with regard to the traffic description sub-TLVs 1100 and the traffic description sub-TLV 1200, three multicast mappings may be achieved, as follows. First, (S, G): S bit=0, G bit=0, the source address and group multicast address prefixes are both used to define the multicast traffic. Second, (*, G): S bit=1, G bit=0, the group multicast address prefix is used to define the multicast traffic, but the source address prefix is ignored. Third, (*, *): S bit=1, G bit=1, the source address and group multicast address prefixes are both ignored.

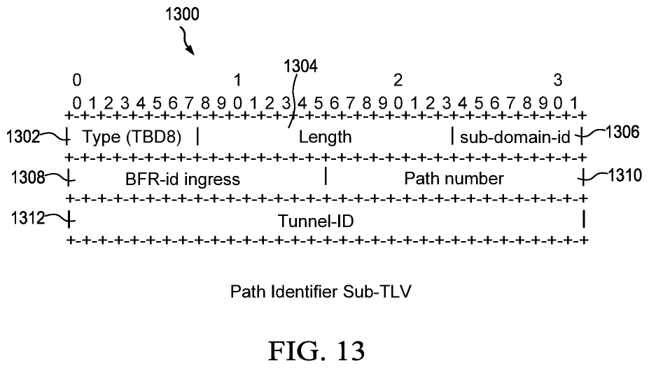

FIG. 13 is a schematic diagram of a path identifier sub-TLV 1300. The path identifier sub-TLV 1300 comprises a type field 1302, a length field 1304, a sub-domain ID field 1306, a BFR ID ingress field 1308, a path number field 1310, and a tunnel ID field 1312. The type field 1302 includes a value that indicates that the sub-TLV is a path identifier sub-TLV 1300. The length field 1304 includes a value that indicates a length of the sub-TLV. The sub-domain ID field 1306 includes a value that indicates a sub-domain ID (sub-domain-id). The BFR ID ingress field 1308 includes a value that indicates the BFR ID of the ingress (BFR-id ingress). The path number field 1310 includes a value that indicates the path number. The tunnel ID field 1312 includes a value that uniquely identifies a BIER-TE tunnel within the ingress and sub domain.

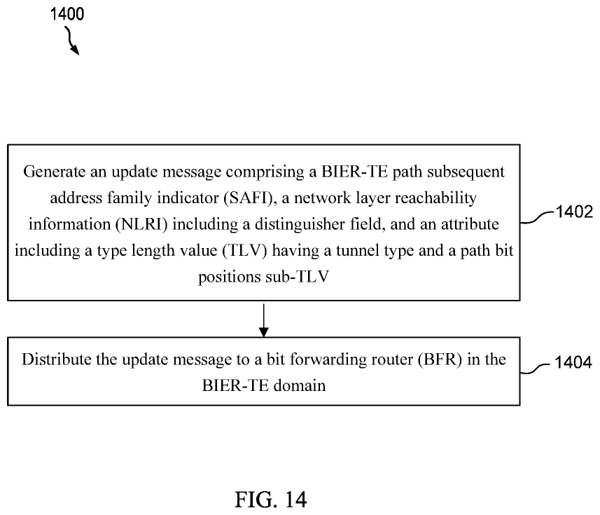

FIG. 14 is a method 1400 implemented by a controller (e.g., controller 130) configured to implement BGP and control a BIER-TE domain (e.g., BIER-TE domain 102). The method 1400 may be performed by the controller to calculate and distribute a BIER-TE path to one or more network nodes.

In block 1402, the controller generates an update message comprising a BIER-TE path subsequent address family indicator (SAFI), a network layer reachability information (NLRI) including a distinguisher field, and an attribute including a type length value (TLV) having a tunnel type and a path bit positions sub-TLV.

In an embodiment, the distinguisher field comprises a value that uniquely identifies content associated with the NLRI or of a BIER-TE path. In an embodiment, the NLRI includes a tunnel identifier field comprising a sub-domain identifier (ID), a bit forwarding router identifier (BFR-id) field, and a tunnel ID field, wherein the sub-domain identifier identifies a sub-domain through which a BIER-TE tunnel crosses, the BFR-id field identifies a bit forwarding ingress router (BFIR) of the BIER-TE tunnel, and the tunnel ID field uniquely identifies the BIER-TE tunnel within the BFIR and the sub-domain. The NLRI is associated with or has the attribute including a type length value (TLV) having a tunnel type and a path bit positions sub-TLV.

In an embodiment, the tunnel identifier field comprises a BFR prefix of a bit forwarding ingress router (BFIR) of a BIER-TE tunnel. In an embodiment, the attribute comprises a tunnel encapsulation attribute (TEA). In an embodiment, the attribute comprises a P-Multicast Service Interface (PSMI) tunnel attribute (PTA). In an embodiment, the path bit positions sub-TLV includes a bit index forwarding table identifier (BIFT-id) field, a set identifier (SI) field, and a bitstring field. In an embodiment, the update message is distributed to a BGP peer running on a bit forwarding ingress router (BFIR) of the BIER-TE domain.

In an embodiment, the TLV further comprises a path name sub-TLV that encodes a name of a BIER-TE path. In an embodiment, the TLV further comprises a traffic description sub-TLV that encodes multicast traffic transported by a BIER-TE path. In an embodiment, the TLV further comprises a service sub-TLV that contains a service identifier (ID) or a label to be added into a packet to be carried by a BIER-TE path.

In an embodiment, the TLV further comprises a path identifier sub-TLV that contains a sub-domain identifier (sub-domain-id) field, a bit forwarding ingress router identifier (BFIR-id) field, a tunnel ID field, and a path number field. In an embodiment, the update message further comprises an address family indicator (AFI) that identifies Internet Protocol version four (IPv4) or Internet Protocol version six (IPv6).

In block 1404, the controller distributes the update message to a bit forwarding router (BFR) in the BIER-TE domain. In an embodiment, the controller distributes the update message directly to the ingress BFR. In an embodiment, the controller distributes the update message to a neighbor network node of the ingress network node, and the neighbor network node advertises the update message to the ingress network node.

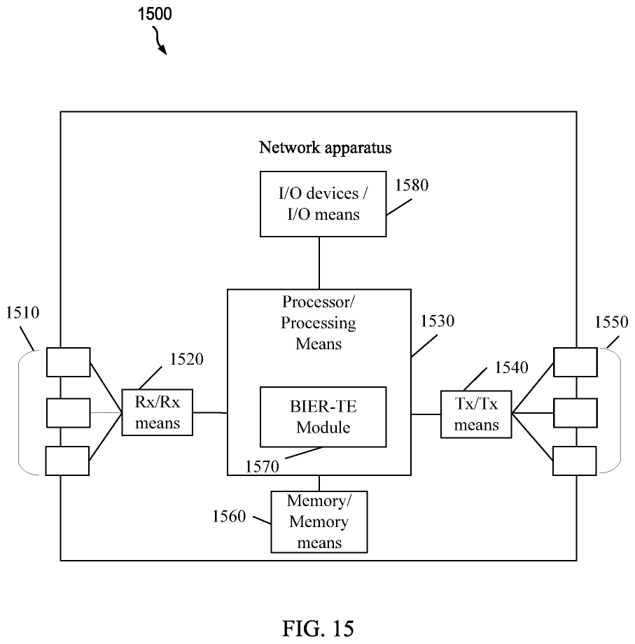

FIG. 15 is a schematic diagram of a network apparatus 1500 (e.g., a network controller, a network node, etc.). The network apparatus 1500 is suitable for implementing the disclosed embodiments as described herein. The network apparatus 1500 comprises ingress ports/ingress means 1510 (a.k.a., upstream ports) and receiver units (Rx)/receiving means 1520 for receiving data; a processor, logic unit, or central processing unit (CPU)/processing means 1530 to process the data; transmitter units (Tx)/transmitting means 1540 and egress ports/egress means 1550 (a.k.a., downstream ports) for transmitting the data; and a memory/memory means 1560 for storing the data. The network apparatus 1500 may also comprise optical-to-electrical (OE) components and electrical-to-optical (EO) components coupled to the ingress ports/ingress means 1510, the receiver units/receiving means 1520, the transmitter units/transmitting means 1540, and the egress ports/egress means 1550 for egress or ingress of optical or electrical signals.

The processor/processing means 1530 is implemented by hardware and software. The processor/processing means 1530 may be implemented as one or more CPU chips, cores (e.g., as a multi-core processor), field-programmable gate arrays (FPGAs), application specific integrated circuits (ASICs), and digital signal processors (DSPs). The processor/processing means 1530 is in communication with the ingress ports/ingress means 1510, receiver units/receiving means 1520, transmitter units/transmitting means 1540, egress ports/egress means 1550, and memory/memory means 1560. The processor/processing means 1530 comprises a BIER-TE module 1570. The BIER-TE module 1570 is able to implement the methods disclosed herein. The inclusion of the BIER-TE module 1570 therefore provides a substantial improvement to the functionality of the network apparatus 1500 and effects a transformation of the network apparatus 1500 to a different state. Alternatively, the BIER-TE module 1570 is implemented as instructions stored in the memory/memory means 1560 and executed by the processor/processing means 1530.

The network apparatus 1500 may also include input and/or output (I/O) devices or I/O means 1580 for communicating data to and from a user. The I/O devices or I/O means 1580 may include output devices such as a display for displaying video data, speakers for outputting audio data, etc. The I/O devices or I/O means 1580 may also include input devices, such as a keyboard, mouse, trackball, etc., and/or corresponding interfaces for interacting with such output devices.

The memory/memory means 1560 comprises one or more disks, tape drives, and solid-state drives and may be used as an over-flow data storage device, to store programs when such programs are selected for execution, and to store instructions and data that are read during program execution. The memory/memory means 1560 may be volatile and/or non-volatile and may be read-only memory (ROM), random access memory (RAM), ternary content-addressable memory (TCAM), and/or static random-access memory (SRAM).

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by a controller configured to implement a border gateway protocol (BGP) and control a Bit Index Explicit Replication Traffic/Tree Engineering (BIER-TE) domain, comprising:
generating an update message comprising a BIER-TE path subsequent address family indicator (SAFI), a network layer reachability information (NLRI) including a distinguisher field, and an attribute including a type length value (TLV) having a tunnel type and a path bit positions sub-TLV; and
distributing the update message to a bit forwarding router (BFR) in the BIER-TE domain.

2. The method of claim 1, wherein the distinguisher field comprises a value that uniquely identifies content associated with the NLRI or of a BIER-TE path.

3. The method of claim 1, wherein the NLRI includes a tunnel identifier field comprising a sub-domain identifier (ID), a bit forwarding router identifier (BFR-id) field, and a tunnel ID, wherein the sub-domain identifier identifies a sub-domain through which a BIER-TE tunnel crosses, the BFR-id field identifies a bit forwarding ingress router (BFIR) of the BIER-TE tunnel, and the tunnel ID uniquely identifies the BIER-TE tunnel within the BFIR and the sub-domain.

4. The method of claim 3, wherein the tunnel identifier field comprises a BFR prefix of the BFIR of the BIER-TE tunnel.

5. The method of claim 1, wherein the attribute comprises a tunnel encapsulation attribute (TEA).

6. The method of claim 1, wherein the attribute comprises a P-Multicast Service Interface (PSMI) tunnel attribute (PTA).

7. The method of claim 1, wherein the path bit positions sub-TLV includes a bit index forwarding table identifier (BIFT-id) field, a set identifier (SI) field, and a bitstring field.

8. The method of claim 1, wherein the update message is distributed to a BGP peer running on a bit forwarding ingress router (BFIR) of the BIER-TE domain.

9. The method of claim 1, wherein the TLV further comprises a path name sub-TLV that encodes a name of a BIER-TE path.

10. The method of claim 1, wherein the TLV further comprises a traffic description sub-TLV that encodes multicast traffic transported by a BIER-TE path.

11. The method of claim 1, wherein the TLV further comprises a service sub-TLV that contains a service identifier (ID) or a label to be added into a packet to be carried by a BIER-TE path.

12. The method of claim 1, wherein the TLV further comprises a path identifier sub-TLV that contains a sub-domain identifier (sub-domain-id) field, a bit forwarding ingress router identifier (BFIR-id) field, a tunnel identifier (ID), and a path number field.

13. The method of claim 1, wherein the update message further comprises an address family indicator (AFI) that identifies Internet Protocol version four (IPv4) or Internet Protocol version six (IPv6).

14. A controller configured to implement a border gateway protocol (BGP) and control a Bit Index Explicit Replication Traffic/Tree Engineering (BIER-TE) domain, comprising:
a memory storing instructions; and
a processor coupled to the memory, the processor configured to execute the instructions to cause the controller to:
generate an update message comprising a BIER-TE path subsequent address family indicator (SAFI), a network layer reachability information (NLRI) including a distinguisher field and an attribute including a type length value (TLV) having a tunnel type and a path bit positions sub-TLV; and
distribute the update message to a bit forwarding router (BFR) in the BIER-TE domain.

15. The controller of claim 14, wherein the distinguisher field comprises a value that uniquely identifies content associated with the NLRI or of a BIER-TE path.

16. The controller of claim 14, wherein the NLRI includes a tunnel identifier field comprising a sub-domain identifier (ID), a bit forwarding router identifier (BFR-id), and a tunnel ID, wherein the sub-domain identifier identifies a sub-domain through which a BIER-TE tunnel crosses, the BFR-id identifies a bit forwarding ingress router (BFIR) of the BIER-TE tunnel, and the tunnel ID uniquely identifies the BIER-TE tunnel within the BFIR and the sub-domain.

17. The controller of claim 16, wherein the tunnel identifier field comprises a BFR prefix of the BFIR of the BIER-TE tunnel.

18. The controller of claim 14, wherein the attribute comprises a tunnel encapsulation attribute (TEA).

19. The controller of claim 14, wherein the attribute comprises a P-Multicast Service Interface (PSMI) tunnel attribute (PTA).

20. The controller of claim 14, wherein the path bit positions sub-TLV includes a bit index forwarding table identifier (BIFT-id) field, a set identifier (SI) field, and a bitstring field.

21. The controller of claim 14, wherein the update message is distributed to a BGP peer running on a bit forwarding ingress router (BFIR) of the BIER-TE domain.

22. The controller of claim 14, wherein the TLV further comprises a path name sub-TLV that encodes a name of a BIER-TE path.

23. The controller of claim 14, wherein the TLV further comprises a traffic description sub-TLV that encodes multicast traffic transported by a BIER-TE path.

24. The controller of claim 14, wherein the TLV further comprises a service sub-TLV that contains a service identifier (ID) or a label to be added into a packet to be carried by a BIER-TE path.

25. The controller of claim 14, wherein the TLV further comprises a path identifier sub-TLV that contains a sub-domain identifier (sub-domain-id) field, a bit forwarding ingress router identifier (BFIR-id) field, a tunnel identifier (ID), and a path number field.

26. The controller of claim 14, wherein the update message further comprises an address family indicator (AFI) that identifies Internet Protocol version four (IPv4) or Internet Protocol version six (IPv6).
